(19) United States
(12) Patent Application Publication
(10) Pub. No.: US 2011/0161860 A1
(43) Pub. Date: Jun. 30, 2011

(54) METHOD AND APPARATUS FOR SEPARATING EVENTS

(75) Inventors: Ryuan CHOI, Suwon-si (KR); Won-joo PARK, Seongnam-si (KR)

(73) Assignee: Samsung Electrics Co., Ltd., Suwon-si (KR)

(21) Appl. No.: 12/979,849

(22) Filed: Dec. 28, 2010

(30) Foreign Application Priority Data
Dec. 28, 2009 (KR) 10-2009-0131846

(51) Int. Cl. G06F 3/033; G06F 3/048

(52) U.S. Cl. 715/781; 715/863

(57) ABSTRACT

An event separating method and apparatus for generating various events is provided. The method includes when a user-input operation starts, determining an event mode according to a position of a start point of the user-input operation; determining a pattern of the input operation; and generating an event corresponding to the pattern, from among events included in the determined event mode.

### PRIORITY

This application claims priority under 35 U.S.C. §119(a) to Korean Patent Application No. 10-2009-0131846, filed on Dec. 28, 2009, in the Korean Intellectual Property Office, the entire contents of which is incorporated herein by reference.

### BACKGROUND OF THE INVENTION

1. Field of the Invention

The present invention relates generally to an input method and apparatus, and more particularly, to a method and apparatus for separating events in an input apparatus that can generate a limited number of input events.

2. Description of the Related Art

Use of portable devices having small touch input screens has been increasing. However, such portable devices can generate only a few input events, such as a click event, a double-click event, a panning event, etc., due to limitations of input apparatuses of the portable devices.

### SUMMARY OF THE INVENTION

The present invention provides an event separating method and apparatus for generating various events.

According to an aspect of the present invention, a method of separating events is provided. The method includes when a user-input operation starts, determining an event mode according to a position of a start point of the user-input operation; determining a pattern of the user-input operation; and generating an event corresponding to the pattern, from among events included in the determined event mode.

According to another aspect of the present invention, a non-transitory computer-readable recording medium having embodied thereon a program for executing a method of separating events is provided. The method includes when a user-input operation starts, determining an event mode according to a position of a start point of the user-input operation; determining a pattern of the user-input operation; and generating an event corresponding to the pattern, from among events included in the determined event mode.

According to another aspect of the present invention, an event separating apparatus is provided. The event separating apparatus includes a touch screen for performing input/output of information; a controller for determining an event mode according a position of a start point of a user-input operation when the user-input operation starts, judging a pattern of the user-input operation, and generating an event corresponding to the pattern, from among events included in the determined event mode.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating an event separating apparatus, according to an embodiment of the present invention;

FIG. 2 is a flowchart illustrating an event separating method, according to an embodiment of the present invention;

FIGS. 3 through 5 are diagrams illustrating screens on which an event separating method is performed, according to an embodiment of the present invention; and

FIGS. 6 and 7 are diagrams illustrating screens on which an event separating method is performed, according to another embodiment of the present invention.

### DETAILED DESCRIPTION OF EMBODIMENTS OF THE PRESENT INVENTION

The present invention will now be described more fully with reference to the accompanying drawings, in which exemplary embodiments of the invention are shown. Accordingly, those of ordinary skill in the art will recognize that various changes and modifications of the embodiments described herein can be made without departing from the scope and spirit of the invention. In the following description, a detailed description of known functions and configurations may be omitted when it may make the subject matter of the present invention rather unclear.

FIG. 1 is a block diagram illustrating an event separating apparatus 100, according to an embodiment of the present invention.

Referring to FIG. 1, the event separating apparatus 100 includes a touch screen 110 for providing input/output of user information and a controller 120 for processing input information and outputting of a result of the processing to the touch screen 110. The event separating apparatus 100 may further include a communication unit 130 for providing a communication service such as a web service. When a user begins an input operation via the touch screen 110, the controller 120 determines an event mode according to a position of a start point of the input operation, determines a pattern of the input operation, and generates an event corresponding to the pattern from among events included in the determined event mode.

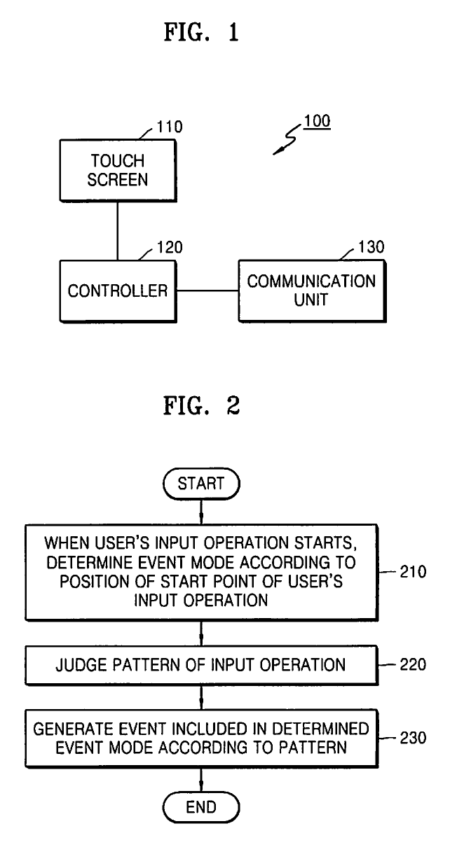

FIG. 2 is a flowchart illustrating an event separating method, according to an embodiment of the present invention.

Referring to FIG. 2, the controller 120 senses whether a user begins an input operation via the touch screen 110, and obtains a position of a start point of the user's input operation. The controller 120 determines an event mode according to the obtained position, in step 210. In order to determine the event mode, a screen may be divided into a plurality of areas, and different event modes corresponding to the divided plurality of areas may be pre-defined. In the present example, the event mode may be determined according to an area that includes the start point of the user's input operation. A pattern is determined by analyzing the input operation, in step 220. An event corresponding to the determined pattern, from among events included in the event mode determined above, is generated, in step 230. Even through different input operations may share a same pattern, different events may be generated according to a present event mode when the input is provided.

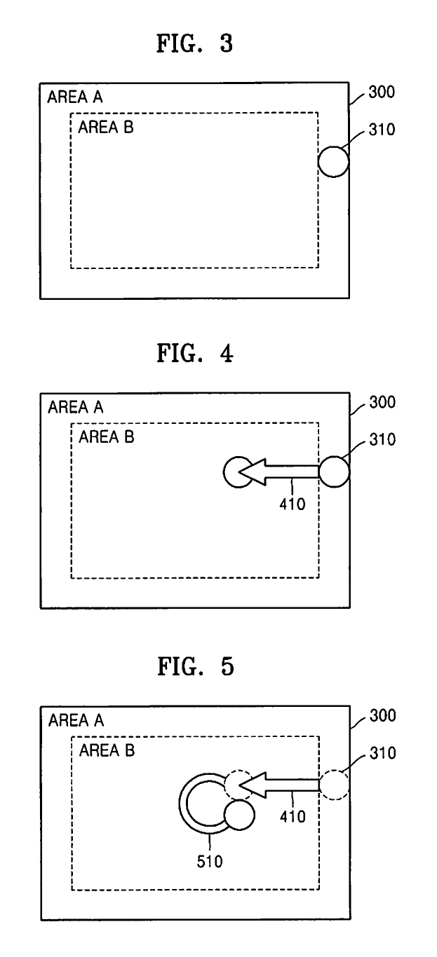

FIGS. 3 through 5 are diagrams illustrating a screen 300 on which an event separating method is performed according to an embodiment of the present invention, wherein the screen 300 is divided into an area A that is an outer area of the screen 300 and an area B that is a remaining area of the screen 300.

Referring to FIG. 3, the screen 300 is divided into outer area A, which includes edges of the screen 300, and inner area B, which includes a center portion of the screen 300. When a user's input operation starts in outer area A, an event mode is determined to be an asynchronous event mode. Meanwhile, when a user's input operation starts in inner area B, an event mode is determined to be a synchronous event mode. In the asynchronous event mode, an asynchronous event such as a gesture is generated. In the synchronous event mode, a synchronous event that immediately reacts to a user's operation is generated.

Referring to FIG. 3, an input operation starts with a user touching or clicking a point 310 included in outer area A. Since a start point of the input operation exists in outer area A, an event mode is determined to be an asynchronous event mode. Referring to FIG. 4, the user moves from the point 310, and thus a move input 410 is generated. Referring to FIG. 5, when the user draws a circle 510 counterclockwise, the controller 120 determines a pattern by analyzing a series of input operations, and generates an asynchronous event defined in correspondence to the counterclockwise circle pattern. For example, a zooming-in event instructing to enlarge a portion of the screen is generated, and thus a portion corresponding to the user's gesture is enlarged.

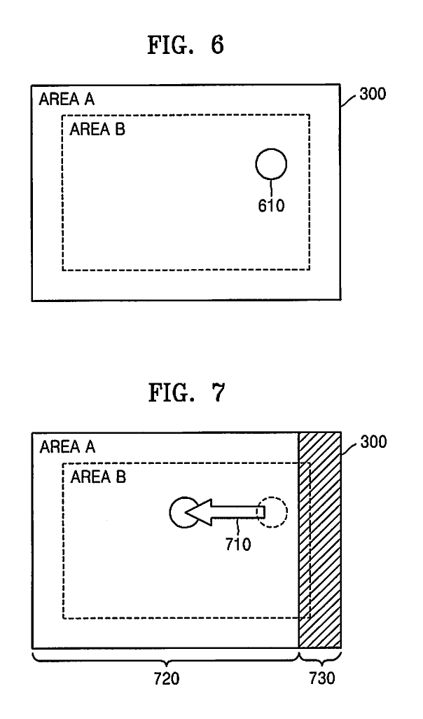

FIGS. 6 and 7 are diagrams illustrating the screen 300 on which an event separating method is performed, according to another embodiment of the present invention.

Referring to FIG. 6, similarly to FIGS. 3 through 5, the screen 300 is divided into an area A that is an outer area of the screen 300 and an area B that is a remaining area of the screen 300. An input operation starts with a user touching or clicking a point 610 included in the inner area B. Since a start point of the input operation exists in the inner area B, an event mode is determined to be a synchronous event mode. Referring to FIG. 7, the user moves from the point 610, and thus a move input 710 is generated. Since the present mode is the synchronous event mode, when the move input 710 starts, a panning event is immediately generated, and thus movement of contents corresponding to the panning event is performed. That is, contents 720 displayed on the screen 300 are moved to the left, and then next contents 730 are displayed.

In the embodiments of the present invention described with reference to FIGS. 3 through 7, the screens 300 are divided into the outer area A and the inner area B, but the present invention is not limited thereto. A screen according to embodiments of the present invention may be divided into a boundary line and a remaining area, and the boundary line and the remaining area may correspond to different event modes, respectively. Alternatively, in the entire area of a touch screen, a portion outside a display portion of the touch screen may be configured so that touch recognition may be performed thereon. Thus, different events may be generated with respect to an input operation starting in the display portion of the touch screen, and while other events may be generated with respect to an input operation starting in the portion outside the display portion.

According to the present invention, various events can be generated without requiring additional operations such as a user pushing one or more additional buttons. Therefore, a more convenient user interface can be realized by embodiments of the present invention.

The present invention can also be embodied as computer readable code on a computer readable recording medium. A computer readable recording medium may be any data storage device that can store data, which can be thereafter read by a computer system. Examples of computer readable recording mediums include Read-Only Memory (ROM), Random-Access Memory (RAM), Compact Disc (CD)-ROMs, magnetic tapes, floppy disks, optical data storage devices, flash memory, etc. The computer readable recording medium can also be distributed over network coupled computer systems, such that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A method of separating events, the method comprising:
when a user-input operation starts, determining an event mode according to a position of a start point of the user-input operation;
determining a pattern of the user-input operation; and
generating an event corresponding to the pattern, from among events included in the determined event mode.

2. The method of claim 1, wherein determining the event mode comprises:
dividing a screen into a plurality of areas; and
determining the event mode according to an area from among the divided plurality of areas that includes the start point of the user-input operation.

3. The method of claim 1, wherein determining the event mode comprises:
dividing the screen into an outer area and a remaining area; and
when the start point of the user-input operation is included in the outer area, determining that the event mode is a mode in which an asynchronous event is generated, and when the start point of the user's input operation is included in the remaining area, determining that the event mode is a mode in which a synchronous event is generated.

4. The method of claim 3, wherein generating the event comprises;
when the input operation starts with a panning operation, if the event mode is the synchronous event mode, generating a panning event; and
if the event mode is the asynchronous event mode, generating a corresponding asynchronous event by analyzing a series of following input operations.

5. A non-transitory computer-readable recording medium having embodied thereon a program for executing a method of separating events, the method comprising:
when a user-input operation starts, determining an event mode according to a position of a start point of the user-input operation;
determining a pattern of the user-input operation; and
generating an event corresponding to the pattern, from among events included in the determined event mode.

6. An event separating apparatus comprising:
a touch screen for performing input/output of information;
a controller for determining an event mode according a position of a start point of a user-input operation when the user-input operation starts, determining a pattern of the user-input operation, and generating an event corresponding to the pattern, from among events included in the determined event mode.

7. The event separating apparatus of claim 6, wherein the controller divides the touch screen into a plurality of areas and determines an event mode according to an area from among the plurality of areas that includes the start point of the user-input operation.

8. The event separating apparatus of claim 6, wherein the controller divides the touch screen into an outer area and a remaining area, determines that the event mode is a mode in which an asynchronous event is generated when the start point of the user-input operation is included in the outer area, and determines the event mode is a mode in which a synchronous event is generated when the start point of the user-input operation is included in the remaining area.

9. The event separating apparatus of claim 8, wherein when the input operation starts with a panning operation, if the event mode is the synchronous event mode, the controller generates a panning event, and if the event mode is the asynchronous event mode, the controller generates a corresponding asynchronous event by analyzing a series of following input operations.
